(19) United States
(12) Patent Application Publication
(10) Pub. No.: US 2026/0116736 A1
(43) Pub. Date: Apr. 30, 2026

(54) MULTI-PUMP SYSTEM FOR MIXING RATIOS

(71) Applicant: L'Oreal, Paris (FR)

(72) Inventors: Ayoub HBAICH, Franklin Park, NJ (US); Rafael FELICIANO, New Providence, NJ (US)

(73) Assignee: L'Oreal, Paris (FR)

(21) Appl. No.: 18/930,657

(22) Filed: Oct. 29, 2024

(51) Int. Cl. B67D 1/12; B67D 1/10

(52) U.S. Cl. CPC B67D 1/122; B67D 1/108

(57) ABSTRACT

A dispenser system, including a first pump configured to dispense a first formula, a second pump configured to dispense a second formula, a first flow rate sensor configured to detect a flow rate of the first formula, a second flow rate sensor configured to detect a flow rate of the second formula, a mixing chamber configured to mix the first formula and the second formula, and a processor, configured to receive one or more commands to adjust the flow rate of the first formula, the second formula, or a combination thereof, and adjust the first pump, the second pump, or a combination thereof based on the one or more commands.

### SUMMARY

In one aspect, disclosed herein is a dispenser system, including a first pump configured to dispense a first formula, a second pump configured to dispense a second formula, a first flow rate sensor configured to detect a flow rate of the first formula, a second flow rate sensor configured to detect a flow rate of the second formula, a mixing chamber configured to mix the first formula and the second formula, and a processor, configured to receive one or more commands to adjust the flow rate of the first formula, the second formula, or a combination thereof, and adjust the first pump, the second pump, or a combination thereof based on the one or more commands.

In some embodiments, the one or more commands are transmitted from a cartridge communication chip.

In some embodiments, the processor is further configured to transmit the flow rate of the first formula from the first flow rate sensor to the cartridge communication chip, and adjust the first pump to adjust the first flow rate. In some embodiments, the processor is further configured to transmit the flow rate of the second formula from the second flow rate sensor to the cartridge communication chip, and adjust the second pump to adjust the second flow rate.

In some embodiments, the one or more commands comprise a predetermined mixing ratio of the first formula and the second formula. In some embodiments, the one or more commands comprise a predetermined first flow rate, a predetermined second flow rate, or a combination thereof. In some embodiments, the first predetermined flow rate is based on a viscosity of the first formula. In some embodiments, the first flow rate of the first formula is above or below the predetermined first flow rate, the processor directs the first pump to adjust the first flow rate. In some embodiments, the first flow rate of the first formula is above or below the predetermined first flow rate, the cartridge communication chip directs the first pump to adjust the first flow rate. In some embodiments, the second predetermined flow rate is based on a viscosity of the second formula. In some embodiments, when the second flow rate of the second formula is above or below the predetermined second flow rate, the processor directs the second pump to adjust the second flow rate. In some embodiments, when the second flow rate of the second formula is above or below the predetermined second flow rate, the cartridge communication chip directs the second pump to adjust the second flow rate.

In another aspect, disclosed herein is a device including the dispenser system disclosed herein and a cartridge communication chip configured to transmit one or more commands.

In yet another aspect, disclosed herein is a method of dispensing a first formula and a second formula with the dispensing system described herein, the method including receiving one or more commands to adjust the flow rate of the first formula, the second formula, or a combination thereof, and adjusting the first pump, the second pump, or a combination thereof based on the one or more commands.

In some embodiments, the method further includes transmitting the flow rate of the first formula from the first flow rate sensor to a cartridge communication chip, and adjusting the first pump to adjust the first flow rate. In some embodiments, the method further includes transmitting the flow rate of the second formula from the second flow rate sensor to a cartridge communication chip and adjusting the second pump to adjust the second flow rate.

In some embodiments, the method includes directing the first pump to adjust the first flow rate when the first flow rate of the first formula is above or below a predetermined first flow rate with the processor. In some embodiments, the method includes directing the first pump to adjust the first flow rate when the first flow rate of the first formula is above or below the predetermined first flow rate with a cartridge communication chip. In some embodiments, the method includes directing the second pump to adjust the second flow rate when the second flow rate of the second formula is above or below the predetermined second flow rate with the processor. In some embodiments, the method includes directing the second pump to adjust the second flow rate when the second flow rate of the second formula is above or below the predetermined second flow rate with a cartridge communication chip.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIG. 1 is an example device, in accordance with the present technology;

FIG. 2 is an exploded view of an example formula cartridge, in accordance with the present technology;

FIG. 3 is an internal view of an example device, in accordance with the present technology;

FIG. 4 is a simplified view of an example dispenser system, in accordance with the present technology;

FIG. 5 is an example method of using a dispenser system, in accordance with the present technology; and

FIG. 6 is another example method of using a dispenser system, in accordance with the present technology.

The foregoing aspects and many of the attendant advantages of this invention will become more readily appreciated as the same become better understood by reference to the following detailed description, when taken in conjunction with the accompanying drawings.

### DETAILED DESCRIPTION

Described herein are devices, systems, and methods for the dynamic adjustment of a multi-pump system. In some embodiments, the multi-pump system includes two pumps, but it should be understood that any number of pumps may be used. In some embodiments, the dispensing systems disclosed herein include a two-way communication mechanism that allows tracking the flow rate of one or more formulas, and real-time adjustment of the flow rates. In this manner, the devices, systems, and methods disclosed herein allow for variation and control of mixing ratios between the one or more formulas, and/or allow for variation and control of flow rate of the one or more formulas. In some embodiments, the devices, systems and methods disclosed herein optimize the performance of a dispensing system or device based on formula specification such as viscosity, and/or optimize performance based on values attained from the flow rate sensors. Different formulas may be adjusted independently or dependently. Communication and adjustment through a feedback loop may adjust flow rate dependent on formula specifications (such as viscosity) received from a communication chip. In some embodiments, a feedback and adjustment loop that can adjust flow rate dependent on measured flow rate value real time from the flow rate sensors.

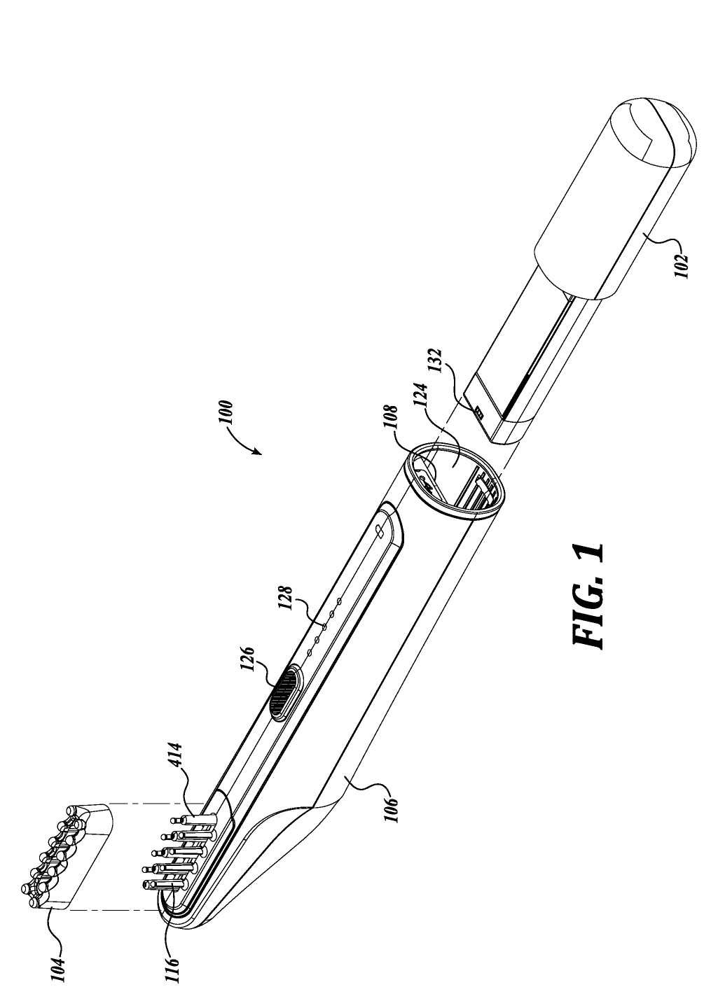

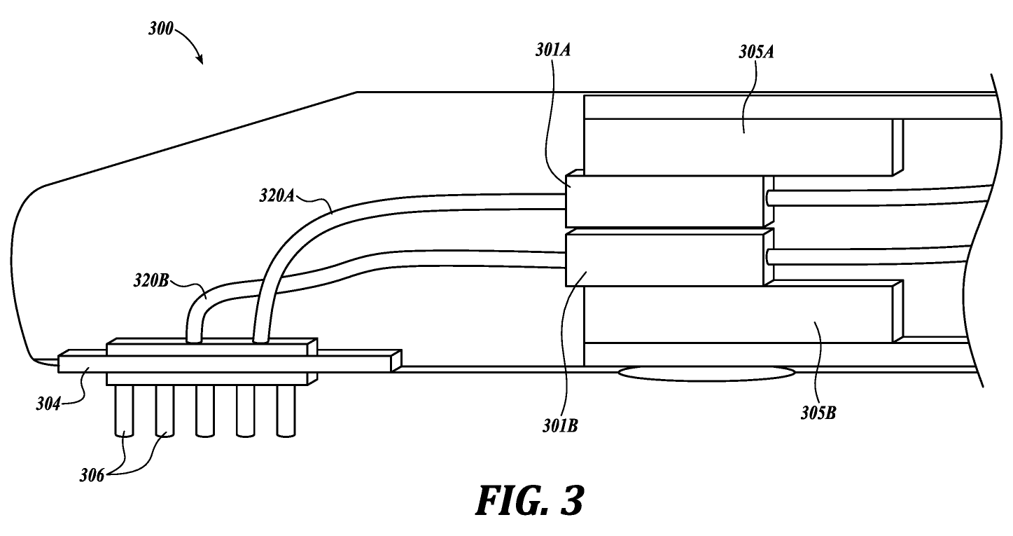

FIG. 1 is an example device 100, in accordance with the present technology. Illustrated is a representative formulation delivery device 100, and components thereof, in accordance with an embodiment of the present disclosure. The formulation delivery device 100 is configured to receive a formulation cartridge 102 type (including a cleaning cartridge of the same type). An embodiment of a formulation cartridge of the formulation cartridge 102 type is described below in detail with respect to FIG. 3; the formulation cartridge 102 shown in FIG. 1 shall be understood to have the same features as described there. Some embodiments of formulation delivery device 100 include the formulation cartridge 102 and/or an optional pull through adapter 104.

Formulation delivery device 100 includes a reusable handle 106 formed from an ABS plastic or similar rigid polymer or other material, and in some embodiments is an assembly formed from a plurality of shells configured to be joined together with fastening elements such as snaps, screws, or the like. Reusable handle 106 has a hollow, elongate gripping portion with a cartridge cavity therein which is sized and dimensioned to receive the formulation cartridge 102 type. In some embodiments, the cavity includes keying features that facilitate correct insertion of the formulation cartridge 102 type. For example, some embodiments include a cartridge interface 108 disposed in the opening and having a flat docking surface that interfaces with a corresponding docking surface of the formulation cartridge 102 when the latter is correctly inserted into the opening.

A controller (not shown in FIG. 1) includes logic configured for operation on a non-transitory machine-readable storage medium, and includes modules that personalize the user experience, provide helpful analytics, and enable e-commerce. In some embodiments, a corresponding application runs on a mobile device such as a smartphone, a tablet, or the like, and interacts with a user (e.g., an end user or a salon technician) to provide actionable information through a plurality of modules. In some embodiments, the application communicates with the formulation delivery device 104 and a network, such as a mobile network, a cloud-based enterprise network, a local area network, or the like.

Together, the formulation cartridge 102, formulation delivery device 104, and application provide an improved, customized, user experience. In some embodiments. the formulation delivery device 104 is a connected electromechanical appliance that interacts with the user, with formulation cartridges 102, and optionally with the application in order to provide a customized and personalized user experience.

Generally, formulation delivery device 104 includes a reusable handle 106 configured to receive the formulation cartridge 102 type, as well as a formulation dispensing assembly and a controller, both disposed in the reusable handle. The formulation dispensing assembly comprises at least one fluid conduit fluidically connected to a motorized pump and to a reciprocating nozzle assembly and is configured to draw formulation or cleaning liquid from the formulation cartridge 110 and to dispense the same through the reciprocating nozzle assembly onto a hair portion, scalp portion, or body portion of a user.

The controller is configured to toggle between at least a cleaning routine and formulation routine responsive to one or more inputs indicative of the cleaning cartridge or the formulation cartridge 102 inserted into the reusable handle 106.

In some embodiments, the formula delivery device 104 further includes a cartridge interface 108 configured to accept the formula cartridge 102, a reciprocating nozzle assembly 114 configured to move a plurality of nozzles or standoff protrusions 116, a button 126 to operate the formula delivery device 104, visual indicators 128 (such as light-emitting diodes (LEDs)) indicating a status of the formula delivery device 104, a cartridge cavity 124 configured to accept the formula cartridge 102, and an encryption chip 132.

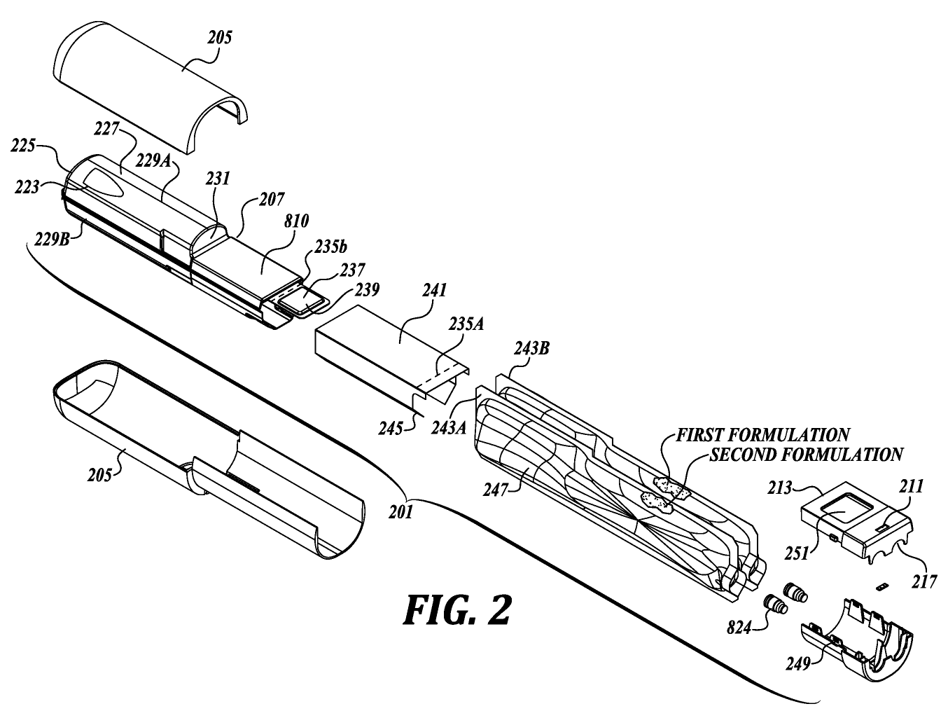

FIG. 2 is an exploded view of an example formula cartridge, in accordance with the present technology. In some embodiments, the cartridge refill unit 201 generally includes a refill packet comprising a shell 207 enclosing at least one formulation vessel (e.g., a packet, pouch, or other vessel), for example a first formulation pouch 243A and a second formulation pouch 243B, and a valve frame 213 coupled with the refill packet, e.g., a front body portion 209 of the shell 207. The first formulation pouch 243A and second formulation pouch 243B respectively contain a first formulation and a second formulation. The refill unit 201 may optionally include packet sleeve 241.

Each of first formulation pouch 243A and second formulation pouch 243B has a volume of about 40mL to about 70mL, about 50mL to about 60mL, about 40mL to about 65mL, about 40mL to about 60mL, about 40mL to about 55mL, about 40mL to about 50mL, about 45mL to about 70mL, about 50mL to about 70mL, about 55mL to about 70mL, about 60mL to about 70mL, or about 55mL. In some embodiments, first formulation pouch 243A and second formulation pouch 243B have different volumes. In some embodiments, refill unit 201 stores only a single formulation vessel.

The first formulation and second formulation can each be any of the formulations described herein, for example a permanent hair dye; semi-permanent hair dye; developer; conditioner; hair growth treatment, such as minoxidil; hair protein treatment; disulfide bond repairing hair treatment; fluid hair treatment; fluid scalp treatment, or the like. In some embodiments, the first formulation and second formulation differ. For example, in some embodiments, the first formulation is a hair dye and the second formulation is a developer. In other embodiments, the first formulation and second formulation are the same (e.g., a conditioner or scalp treatment formulation).

As shown in FIG. 2, each formulation pouch 243A, 243B includes a formulation-containing packet 247 and valve means for selectively-fluidic coupling the refill unit to a dispensing nozzle unit of a formulation delivery device when the formulation cartridge 102 is received within the hand-held formulation dispensing device. Representative valve means include a valve 215 through which the formulation exits the packet 247. Representative formulation vessels are described in International Patent Application Publication No. 2019/067336A2, published April 4, 2019 and assigned to L'Oreal SA, and U.S. Patent Application Publication No. 2021/0196021A1, published July 1, 2021 and assigned to L'Oreal SA, both of which are hereby incorporated by reference in their entireties for all purposes.

The shell 207 has an elongate shape sized to be received within the reusable handle portion 205. Shell 207 encloses and protects the first formulation pouch 243A and second formulation pouch 243B and engages the valve frame 213 (described below). Thus, shell 207 functions as packaging which protects the formulation pouches 243A, 243B during commerce prior to loading into the formulation delivery device.

In some embodiments, shell 207 has a total length between 150mm and 250mm (e.g., 175mm-225mm, 185mm-215mm, 195mm-205mm, or 200mm) and a maximum cross sectional dimension of 25mm-50mm (e.g., 30mm-45mm, 35mm-40mm, or 36mm). Shell 207 has a rear body portion 225 and a slender front body portion 209, e.g., a neck portion, extending away from the body portion 225. The body portion 225 and the slender front body portion 209 generally align in a common longitudinal direction to enable assembly with the reusable handle portion 205, and to enable insertion into the cartridge cavity of the formulation delivery device.

In some embodiments, shell 207 is constructed at least partially from recyclable or recycled material, e.g., a paper material such as an injection-molded paper material or a die-cut structured paper (e.g., cardboard). In the illustrated embodiment, the shell 207 is formed from a single piece of injection-molded paper material. In some embodiments in which the shell 207 is formed of paper, the paper has a weight between 8-12 points (e.g., 8.5 points, 9.0 points, 9.5 points, 10.0 points, 10.5 points, 11.0 points, or 11.5 points), to impart sufficient stiffness without contributing excess disposable material.

The rear body portion 225 of the shell 207 has a larger cross-sectional dimension than the front body portion 209 when viewed in a plane normal to the longitudinal direction of the cartridge 102. A hump or bulge 227 imparts the larger cross-sectional area of the rear body portion 225 relative to the slender front body portion 209. Advantageously, the hump or bulge 227 enables the use of higher-volume formulation pouches 243A, 243B. Additionally, the hump or bulge 227 forms an abutment 231 which abuts a corresponding interior face of the handle portion 205 and secures the longitudinal position of the shell 207 during use.

The slender front body portion 209 of the shell 207 is sized to fit within the tray portion 219 of the handle portion 205 and to project into the cartridge cavity of the formulation delivery device during use. In some embodiments, the front body portion 209 couples with the valve frame 213. To facilitate secure connection and alignment with the valve frame 213, front body portion 209 includes valve frame coupling means, for example at least one coupling tab 237 configured to selectively engage the valve frame 213. In the illustrated embodiment, the front body portion 209 includes a single coupling tab 237 extending away from a front end thereof. The coupling tab 237 includes an engagement feature, for example a detent or raised prominence 239 shaped and sized to engage a complementary aperture 251 of the valve frame 213.

The body portion 209 may have many different configurations. For example, the illustrated body portion 209 is a clamshell configuration formed with at least two partial shells (in this embodiment, two halves 229A, 229B) coupled by a hinge, for example a living hinge integrally formed with the two halves. In some embodiments, the shell 219 includes a different number of partial shells, e.g., three or four partial shells which come together to enclose the formulation pouches 243A, 243B. Alignment of the halves 229A, 229B enables correct attachment of the front body portion 209 to the valve frame 213.

While the illustrated body 207 is formed of an injection molded paper material, this construction is representative, not limiting. In some embodiments, the body 207 is formed of a single piece of die-cut paper stock, which is folded to impart a three-dimensional structure having the rear body portion 225 and slender neck portion 209 extending away therefrom. In some such embodiments, this folded construction creates a polygonal cross section in the rear body portion 225 and a polygonal cross section in the front body portion 209 (for example, octagonal and hexagonal cross sections, respectively). To facilitate assembly, some such embodiments of the shell 207 include one or more scores or guidelines that ensure correct folding. Some embodiments have a triangular, rectangular, pentagonal, hexagonal, heptagonal, octagonal, or other polygonal cross-sectional shape.

Optional packet sleeve 241 slides over the neck portion 209 and provides several important advantages. First, it imparts additional structure to the refill unit 201 by sliding over and reinforcing front body portion 209. Accordingly, in some embodiments, packet sleeve 241 has a greater weight or thickness as compared to the material that forms shell 207; although this is not required. In some embodiments, packet sleeve 241 is also formed of recyclable material, which may be the same material as the shell 207.

Second, in some embodiments, packet sleeve 241 couples with the valve frame 213. For example, the illustrated packet sleeve 241 includes a plurality of engagement member recesses 235 configured to reversibly couple with engagement members of the valve frame 213.

Third, packet sleeve 241 facilitates disassembly of the refill unit 201. In some embodiments, packet sleeve 241 includes an optional integral tearaway 235A formed thereon (e.g., a perforation with a pull tab). In other embodiments, the tearaway is formed on the neck portion 209 (see tearaway 235B). In use, after the formulation packets 243A, 243B are depleted, a user pulls the pull tab of integral tearaway 235A and/or 235B, thereby separating valve frame 213 from packet sleeve 241. Upon completion of this action, the packet sleeve 241 is recycled and the valve frame 213 is discarded. In some embodiments, the integral tearaway 836 is disposed on the shell 207, e.g., the front body portion 209.

Valve frame 213 provides a rigid structure which aligns the formulation pouch valves 215 for correct fluid interconnection with the fluid conduits of the formulation delivery device. Additionally, in some embodiments, valve frame 213 supports an optional encryption chip 132 as described above. In such embodiments, valve frame 213 is sized and shaped to accurately position the encryption chip 132 adjacent to the cartridge authentication interface of the formulation delivery device when the formulation cartridge 102 is disposed in the handle of the formulation delivery device. Accordingly, valve frame 213 is formed from ABS plastic, HDPE, or other rigid polymer or other material. In some embodiments, valve frame 213 is formed from a same material as shell 219.

A plurality of valve engagement units 217 extend through a front end of the valve frame 213. Each valve engagement unit 217 receives and secures one of the formulation pouch valves 215. In some embodiments, the valve engagement unit 217 is a valve aperture or cutout disposed through a face of the valve frame 213, the valve aperture or cutout being sized to receive a valve of a formulation pouch and optionally to engage an outer circumference of the valve. To enable coupling with the packet sleeve 241 (or shell 207 in some embodiments), valve frame 213 includes optional engagement members 249 (e.g., tabs) extending therefrom. In some embodiments, valve frame 213 engages with the front body portion 209 by a friction fit.

Encryption chip 211 (e.g., an RFID tag) is disposed on the refill unit 201, e.g., on the body portion 207 or on the valve frame 213 (as in the illustrated embodiment). The encryption chip 211 is positioned on the refill unit 201 such that when the formulation cartridge 102 is inserted into the formulation delivery device, it is positioned to be read by the cartridge authentication interface thereof. Accordingly, the encryption chip 211 stores information about the formulation cartridge 102 and its contents, for example at least one of a formulation identification, a beginning formulation quantity, a formulation expiration date, or a formulation production date.

Thus, the body 207, formulation pouches 243A, 243B, valve frame 213, and optional packet sleeve 241 form the refill unit 201. In use, refill unit 201 is reversibly couplable with handle portion 205, e.g., by securing means such as coupling tabs on the shell 207 or by friction fit between the refill unit 201 and the handle portion 205.

FIG. 3 is an internal view of an example device 300, in accordance with the present technology. In some embodiments, the device 300 includes a first roller pump (or “first peristaltic pump”) 301A, a second roller pump (or “second peristaltic pump”), a first formula tube 302A, a second formula tube 302B, a mixing chamber 304 (which may include a mixer, such as a static mixer), a first motor 305A, a second motor 305B, and a plurality of dispensing nozzles 306.

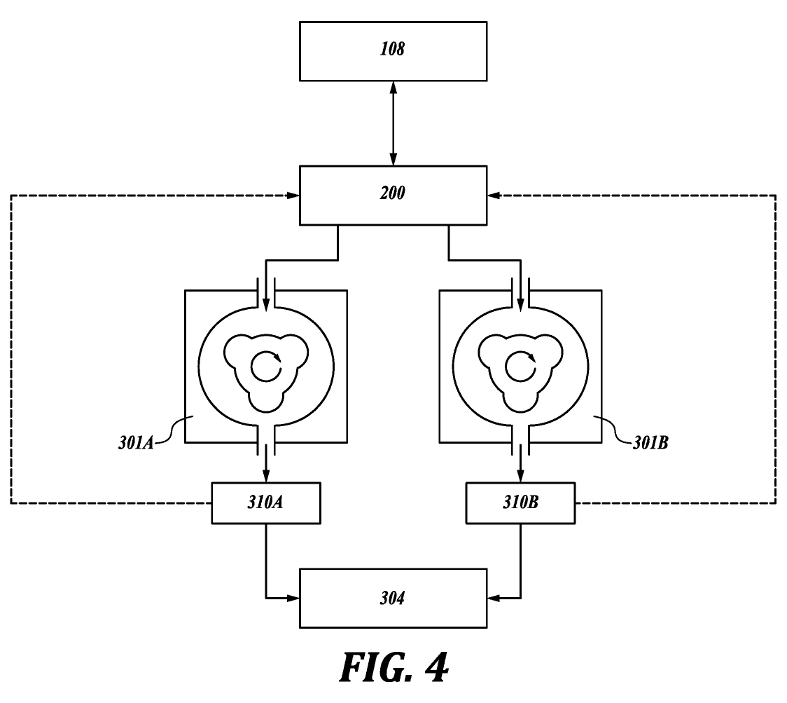

In operation, the first tube 302A is configured to direct a first formulation, while the second tube 302B directs a second formulation. In some embodiments, the first roller pump 301A dispenses the first formulation at a first flow rate into the mixing chamber 304 through the first tube 302A. Similarly, the second roller pump 301B may dispense the second formulation at a second flow rate into the mixing chamber 304 through the second tube 302B. The first roller pump 301A may be driven by a first motor 305A, while the second roller pump 301B may be driven by a second motor 305B. In some embodiments, both the first roller pump 301A and the second roller pump 301B may modify the flow rate (i.e., the first flow rate and/or the second flow rate) of the first formulation and the second formulation, respectively, as explained in detail in FIG. 4.

Once in the mixing chamber 304, a mixer, such as a static mixer (not shown in FIG. 3) may mix the first formulation and the second formulation. In some embodiments, the first formulation and the second formulation are then dispensed from the plurality of nozzles 306.

FIG. 4 is a simplified view of an example dispenser system, in accordance with the present technology. In some embodiments, the dispenser system includes a communication chip 108, a processor 200, a first roller pump 301A, a second roller pump 301B, a first flow rate sensor 310A, a second flow rate sensor 310B, and a mixing chamber 304.

In some embodiments, the communication chip 108 is an encryption chip (as shown and described in FIG. 1). In some embodiments, the communication chip is located on a smart device external from the dispenser system (such as a smartphone, laptop, tablet, or the like).

In some embodiments, the first roller pump (or “first pump”) is configured to dispense a first formula. In some embodiments, the second roller pump (or “second pump” is configured to dispense a second formula. In some embodiments, the first formula, the second formula, or both may be selected from hair dye, hair developer, cosmetics, hair care formulas, shampoo, conditioner, hair mask, moisturizer, or the like.

In some embodiments, the first flow rate sensor 310A configured to detect a flow rate of the first formula. In some embodiments, the first flow rate sensor 310A is disposed directly outside of the first pump 301A. In some embodiments, the first flow rate sensor 310A is located in a first tube (such as first tube 302A in FIG. 3). In some embodiments, the first flow rate sensor 310A is a flow meter. In some embodiments, the first flow rate sensor 310A is an ultrasonic, electromagnetic, Karman vortex, paddlewheel, floating element, thermal, or differential pressure flow rate sensor.

In some embodiments, the second flow rate sensor 310B configured to detect a flow rate of the second formula. In some embodiments, the second flow rate sensor 310B is disposed directly outside of the second pump 301B. In some embodiments, the second flow rate sensor 310B is located in a second tube (such as second tube 302B in FIG. 3). In some embodiments, the second flow rate sensor 310B is a flow meter. In some embodiments, the second flow rate sensor 310B is an ultrasonic, electromagnetic, Karman vortex, paddlewheel, floating element, thermal, or differential pressure flow rate sensor.

In some embodiments, the dispensing system further includes the mixing chamber, which is configured to mix the first formula and the second formula.

In some embodiments, the dispensing system further includes the processor 200. In some embodiments, the processor 200 is configured to receive one or more commands from the communication chip 108. In some embodiments, the processor 200 is configured to receive data from the first flow rate sensor 310A and the second flow rate sensor 310B. The processor 200 may also be configured to direct and/or control the first pump 301A and the second pump 301B. In some embodiments, the processor 200 is configured to receive one or more commands to adjust the flow rate of the first formula, the second formula, or a combination thereof, and adjust the first pump 301A, the second pump 301B, or a combination thereof based on the one or more commands.

In some embodiments, the one or more commands are transmitted from the cartridge communication chip 108 (or “communication chip”). As explained herein, in some embodiments, the cartridge communication chip 108 may be a smart device such as a smartphone or tablet.

In some embodiments, the processor 200 is configured to transmit the flow rate of the first formula from the first flow rate sensor 310A to the cartridge communication chip 108 and adjust the first pump 301A to adjust the first flow rate. In some embodiments, with the first flow rate sensor 310A and the processor 200, a communication loop may be established. Accordingly, the processor 200 and the communication chip 108 may be in two-way communication, to adjust the first flow rate of the first formula in real time, based on the measured flow rate from the first flow sensor 310A and the one or more commands from the communication chip 108.

In some embodiments, the processor 200 is configured to transmit the flow rate of the second formula from the second flow rate sensor to the cartridge communication chip and adjust the second pump 301B to adjust the second flow rate. In some embodiments, with the second flow rate sensor 310B and the processor 200, a communication loop may be established. Accordingly, the processor 200 and the communication chip 108 may be in two-way communication, to adjust the second flow rate of the second formula in real time, based on the measured flow rate from the second flow sensor 310B and the one or more commands from the communication chip 108.

In some embodiments, the term “adjust” in reference to the first pump 301A and/or the second pump 301B means increasing a flow rate, decreasing a flow rate, maintaining a flow rate, or the like. In some embodiments, the term “adjust” in reference to the first pump 301A and/or the second pump 301B means adjusting a rate of rotations of the first pump 301A and/or the second pump 301B, increasing, decreasing, or maintaining a pump speed, or the like.

In some embodiments, the one or more commands include a set flow rate for the first formula and/or the second formula. In some embodiments, the one or more commands include a predetermined mixing ratio of the first formula and the second formula. In some embodiments, the one or more commands comprise a predetermined first flow rate, a predetermined second flow rate, or a combination thereof.

In some embodiments, the first predetermined flow rate is based on a viscosity of the first formula. In some embodiments, when the first flow rate of the first formula is above or below the predetermined first flow rate, the processor 200 directs the first pump 301A to adjust the first flow rate. In some embodiments, when the first flow rate of the first formula is above or below the predetermined first flow rate, the cartridge communication chip 108 directs the first pump 301A to adjust the first flow rate.

In some embodiments, the second predetermined flow rate is based on a viscosity of the second formula. In some embodiments, when the second flow rate of the second formula is above or below the predetermined second flow rate, the processor 200 directs the second pump 301B to adjust the second flow rate. In some embodiments, when the second flow rate of the second formula is above or below the predetermined second flow rate, the cartridge communication chip 108 directs the second pump 301B to adjust the second flow rate.

In some embodiments, the dispenser system is incorporated into a device, such as devices 100 or 200 as shown and described herein. In some embodiments, the dispenser system may operate independently of a device.

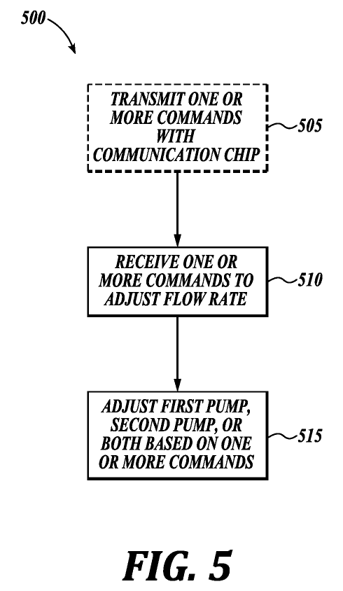

FIG. 5 is an example method 500 of using a dispenser system, in accordance with the present technology. In some embodiments, the method 500 is carried out with a device (such as device 100 or device 200). In some embodiments, the method 500 is carried out with a dispensing system (such as the dispensing system shown in FIG. 4). In some embodiments, the dispensing system is integrated into the device, but in other embodiments, the dispensing system is a standalone system. In some embodiments, the dispensing system includes a processor (such a processor 200), a first pump (such as first pump 301A), a second pump (301B), a first flow rate sensor (such as first flow rate sensor 310A), a second flow rate sensor (such as second flow rate sensor 310B), and a mixing chamber (such as mixing chamber 304). In some embodiments, the dispensing system may further include a first motor (such as first motor 305A), a second motor (such as second motor 305B), a first tube (such as first tube 302A), a second tube (such as second tube 302B), and/or a plurality of dispensing nozzles (such as plurality of dispensing nozzles 306).

Optionally, in block 505, one or more commands are transmitted with a communication chip (such as communication chip 108). In some embodiments, the one or more commands are transmitted with an encryption chip (such as encryption chip 132). In some embodiments, the communication chip 108 is located on an external device, such as a smartphone, tablet, or computer.

In block 510, one or more commands are received to adjust the flow rate of the first formula, the second formula, or a combination thereof. In some embodiments, the one or more commands are received by the processor. In some embodiments, the one or more commands include a set flow rate for the first formula and/or the second formula. In some embodiments, the one or more commands include a predetermined mixing ratio of the first formula and the second formula. In some embodiments, the one or more commands comprise a predetermined first flow rate, a predetermined second flow rate, or a combination thereof.

In block 515, the first pump, the second pump, or a combination thereof may be adjusted based on the one or more commands. In some embodiments, the term “adjust” in reference to the first pump 301A and/or the second pump 301B means increasing a flow rate, decreasing a flow rate, maintaining a flow rate, or the like. In some embodiments, the term “adjust” in reference to the first pump 301A and/or the second pump 301B means adjusting a rate of rotations of the first pump 301A and/or the second pump 301B, increasing, decreasing, or maintaining a pump speed, or the like. In some embodiments, the flow rate of the first formula from the first flow rate sensor is transmitted to a cartridge communication chip, and the first pump is adjusted to adjust the first flow rate. In some embodiments, t the flow rate of the second formula is transmitted from the second flow rate sensor to a cartridge communication chip, and the second pump is adjusted to adjust the second flow rate.

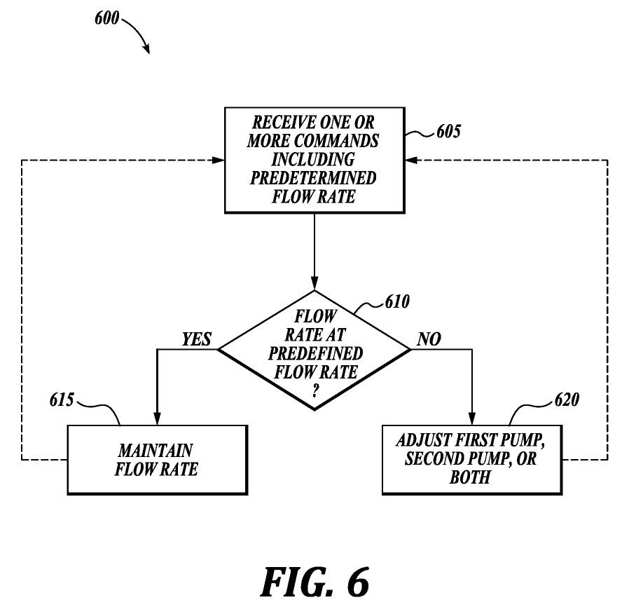

FIG. 6 is another example method 600 of using a dispenser system, in accordance with the present technology. In some embodiments, the method 600 is carried out with a device (such as device 100 or device 200). In some embodiments, the method 500 is carried out with a dispensing system (such as the dispensing system shown in FIG. 4). In some embodiments, the dispensing system is integrated into the device, but in other embodiments, the dispensing system is a standalone system. In some embodiments, the dispensing system includes a processor (such a processor 200), a first pump (such as first pump 301A), a second pump (301B), a first flow rate sensor (such as first flow rate sensor 310A), a second flow rate sensor (such as second flow rate sensor 310B), and a mixing chamber (such as mixing chamber 304). In some embodiments, the dispensing system may further include a first motor (such as first motor 305A), a second motor (such as second motor 305B), a first tube (such as first tube 302A), a second tube (such as second tube 302B), and/or a plurality of dispensing nozzles (such as plurality of dispensing nozzles 306).

In some embodiments, the method 600 may occur after, before, or during the method 500. In some embodiments, the method 600 is a subset of the method 500.

Though method 600 refers to a “predetermined flow rate,” it should be understood that method 600 may refer to a predetermined flow rate of the first formula, a predetermined flow rate of the second formula, or a combination of both.

In block 605, one or more commands are received, where the one or more commands include a predetermined flow rate. In some embodiments, the predetermined flow rate is a flow rate threshold. In some embodiments, the predetermined flow rate is based on a viscosity of the first formulation or the second formulation. In some embodiments, the predetermined flow rate is based on a desired mixing ratio of the first formulation and the second formulation. That is, the predetermined flow rate of the first formulation and/or the second formulation may be adjusted to achieve a mixing ratio.

In decision block 610, it is determined whether the flow rate of the first formula, the second formula, or both meets the predetermined flow rate. If the flow rate is at about the predetermined flow rate (such as within 5%, 10%, or 20% of the predetermined flow rate) for the first formula, the second formula, or both, the method 600 proceeds to block 615.

In block 615, the flow rate of the first formula, the second formula, or both is maintained. While only a single predetermined flow rate is shown in FIG. 6, it should be understood that the flow rate of the first formula and the flow rate of the second formula may each have a predetermined flow rate, such that the flow rate of the first formula and the second flow rate of the second formula are adjusted independently. Alternatively, the predetermined flow rate may be a predetermined mixing ratio of the first formula and the second formula. Accordingly, in such embodiments, the flow rate of the first formula and the second formula may be dependent on one another, and thus be adjusted simultaneously. In some embodiments, the first flow rate sensor, the second flow rate sensor, or both, may create a feedback loop with the processor and/or the communication chip. In such embodiments, this allows for real-time adjustment of the flow rate of the first formula, the second formula, or both.

Returning to decision block 610, when the flow rate is above or below the predetermined flow rate (such as above or below the predetermined flow rate by over 5%, 10%, 20%, or 30%), the method proceeds to block 620.

In block 620, the first pump may be directed to adjust the first flow rate when the first flow rate of the first formula is above or below a predetermined first flow rate with the processor. Further, in some embodiments, the communication chip may adjust the first pump to adjust the first flow rate when the first flow rate of the first formula is above or below the predetermined first flow rate. Similarly, in some embodiments, the second pump may be directed to adjust the second flow rate when the second flow rate of the second formula is above or below the predetermined second flow rate with the processor. In some embodiments, the second pump may be directed to adjust the second flow rate when the second flow rate of the second formula is above or below the predetermined second flow rate with the communication chip. In some embodiments, the first flow rate sensor, the second flow rate sensor, or both, may create a feedback loop with the processor and/or the communication chip. In such embodiments, this allows for real-time adjustment of the flow rate of the first formula, the second formula, or both.

It should be understood that all methods 500, 600 should be interpreted as merely representative. In some embodiments, process blocks of all methods 500, 600 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term "plurality" to reference a quantity or number. In this regard, the term "plurality" is meant to be any number that is more than one, for example, two, three, four, five, etc. The terms "about," "approximately," "near," etc., mean plus or minus 5% of the stated value. For the purposes of the present disclosure, the phrase "at least one of A, B, and C," for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as "vertical," "horizontal," "front," "rear," "left," "right," "top," and "bottom," etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term "plurality" to reference a quantity or number. In this regard, the term "plurality" is meant to be any number that is more than one, for example, two, three, four, five, etc. The term "about," "approximately," etc., means plus or minus 5% of the stated value. The term "based upon" means "based at least partially upon."

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

We claim:

1. A dispenser system, comprising:
a first pump configured to dispense a first formula;
a second pump configured to dispense a second formula;
a first flow rate sensor configured to detect a flow rate of the first formula;
a second flow rate sensor configured to detect a flow rate of the second formula;
a mixing chamber configured to mix the first formula and the second formula; and
a processor, configured to:
receive one or more commands to adjust the flow rate of the first formula, the second formula, or a combination thereof; and
adjust the first pump, the second pump, or a combination thereof based on the one or more commands.

2. The dispenser system of claim 1, wherein the one or more commands are transmitted from a cartridge communication chip.

3. The dispenser system of claim 2, wherein the processor is further configured to:
transmit the flow rate of the first formula from the first flow rate sensor to the cartridge communication chip; and
adjust the first pump to adjust the first flow rate.

4. The dispenser system of claim 2, wherein the processor is further configured to:
transmit the flow rate of the second formula from the second flow rate sensor to the cartridge communication chip; and
adjust the second pump to adjust the second flow rate.

5. The dispenser system of claim 1, wherein the one or more commands comprise a predetermined mixing ratio of the first formula and the second formula.

6. The dispenser system of claim 1, wherein the one or more commands comprise a predetermined first flow rate, a predetermined second flow rate, or a combination thereof.

7. The dispenser system of claim 6, wherein the first predetermined flow rate is based on a viscosity of the first formula.

8. The dispenser system of claim 6, wherein when the first flow rate of the first formula is above or below the predetermined first flow rate, the processor directs the first pump to adjust the first flow rate.

9. The dispenser system of claim 6, wherein when the first flow rate of the first formula is above or below the predetermined first flow rate, the cartridge communication chip directs the first pump to adjust the first flow rate.

10. The dispenser system of claim 6, wherein the second predetermined flow rate is based on a viscosity of the second formula.

11. The dispenser system of claim 10, wherein when the second flow rate of the second formula is above or below the predetermined second flow rate, the processor directs the second pump to adjust the second flow rate.

12. The dispenser system of claim 10, wherein when the second flow rate of the second formula is above or below the predetermined second flow rate, the cartridge communication chip directs the second pump to adjust the second flow rate.

13. A device comprising:
the dispenser system of claim 1; and
a cartridge communication chip configured to transmit one or more commands.

14. A method of dispensing a first formula and a second formula with the dispensing system of claim 1, the method comprising:
receiving one or more commands to adjust the flow rate of the first formula, the second formula, or a combination thereof; and
adjusting the first pump, the second pump, or a combination thereof based on the one or more commands.

15. The method of claim 14, further comprising:
transmitting the flow rate of the first formula from the first flow rate sensor to a cartridge communication chip; and
adjusting the first pump to adjust the first flow rate.

16. The method of claim 14, further comprising:
transmitting the flow rate of the second formula from the second flow rate sensor to a cartridge communication chip; and
adjusting the second pump to adjust the second flow rate.

17. The method of claim 14, further comprising:
directing the first pump to adjust the first flow rate when the first flow rate of the first formula is above or below a predetermined first flow rate with the processor.

18. The method of claim 17, further comprising:
directing the first pump to adjust the first flow rate when the first flow rate of the first formula is above or below the predetermined first flow rate with a cartridge communication chip.

19. The method of claim 14, further comprising:
directing the second pump to adjust the second flow rate when the second flow rate of the second formula is above or below the predetermined second flow rate with the processor.

20. The method of claim 19, further comprising:
directing the second pump to adjust the second flow rate when the second flow rate of the second formula is above or below the predetermined second flow rate with a cartridge communication chip.
